(19) United States
(12) Patent Application Publication
(10) Pub. No.: US 2026/0056587 A1
(43) Pub. Date: Feb. 26, 2026

(54) COOLING ASSEMBLY FOR NON-CONTACT DRIVING STRUCTURE OF COMPUTER

(71) Applicant: DONGGUAN GASSENDI TECHNOLOGY CO., LTD., Dongguan (CN)

(72) Inventors: Hongming ZHU, Yueqing (CN); Zhicheng LIN, Guangzhou (CN)

(73) Assignee: DONGGUAN GASSENDI TECHNOLOGY CO., LTD., Dongguan (CN)

(21) Appl. No.: 18/884,390

(22) Filed: Sep. 13, 2024

(30) Foreign Application Priority Data
Aug. 21, 2024 (CN) 202422037070.6

(51) Int. Cl. G06F 1/20

(52) U.S. Cl. CPC G06F 1/206

(57) ABSTRACT

A cooling assembly for a non-contact driving structure of a computer includes a water chamber and a driving device. The water chamber is a shell provided with an inner cavity, an impeller installed in a pivoted mode is arranged on a top wall of the inner cavity, a disk extending in a radial direction is arranged on an upper portion of the impeller, and the shell is provided with a fluid inlet and a fluid outlet; the driving device includes a pump seat arranged on an upper wall of the water chamber, the pump seat is fixedly provided with a stator, the stator is provided with a rotor matched with each other, the rotor and the stator are arranged in the radial direction, the rotor is located below the stator, and magnetic fields of the stator and the rotor are axially tangent.

### CROSS-REFERENCE TO RELATED APPLICATIONS

This application claims priority to Chinese Patent Application No. 202422037070.6, filed on Aug. 21, 2024, the content of which is incorporated herein by reference in its entirety.

### TECHNICAL FIELD

The present disclosure relates to the field of invention, and in particular to a cooling assembly for a non-contact driving structure of a computer.

### BACKGROUND

Computer water cooling refers to a commonly used liquid cooling system in computers, which uses liquids with high specific heat coefficient (such as water) as a medium to help dissipate heat from internal components. Computer water cooling generally has the following advantages: small temperature fluctuations under cyclic cooling, effective temperature control of cooled components, and stable and reliable performance over long periods of use.

In the current integrated design of water pumps and water chambers, in order to achieve brushless motor-driven impellers, rotors are generally placed inside the impeller. However, the magnetic induction coils of the stator need to be tangent to the device (i.e., the stator is the magnetic induction coil, and the rotor is arranged on the outer periphery of the stator, in a radial tangent). As a result, the shell protrudes and extends into the water chamber, enabling the impeller to drive fluid flow. The corresponding problem is that the water chamber has a large volume and thickness, and since the stator shell extends into the water chamber, the volume of the water chamber is reduced.

Of course, there are also designs that separate the water pump and water chamber, but their overall integrity is poor. Furthermore, with the advent of transparent computer cases, the larger size of the water pump and water chamber also affects the overall aesthetics of the case.

### SUMMARY

The primary objective of the present disclosure is to propose a cooling assembly for a non-contact driving structure of a computer, aimed at achieving an integrated design of the water pump and water chamber with a simple structure, and maintaining the water chamber's capacity while reducing its overall volume.

In order to achieve the above object, the present disclosure provides a cooling assembly for a non-contact driving structure of a computer, comprising:
a water chamber, wherein the water chamber is a shell provided with an inner cavity, an impeller installed in a pivoted mode is arranged on a top wall of the inner cavity, a disk extending in a radial direction is arranged on an upper portion of the impeller, and the shell is provided with a fluid inlet and a fluid outlet;
a driving device, wherein the driving device includes a pump seat arranged on an upper wall of the water chamber, the pump seat is fixedly provided with a stator, the stator is provided with a rotor matched with each other, the rotor and the stator are arranged in the radial direction, the rotor is located below the stator, and magnetic fields of the stator and the rotor are axially tangent.

The rotor is arranged on the disk or the rotor drives the disk to rotate through an intermediate piece; a top wall of the water chamber is a partition plate arranged between the stator and the disk; and when the impeller is rotated, the impeller is arranged to drive fluid from the fluid inlet through the water chamber and into the fluid outlet.

In the actual design, the water chamber is a relatively enclosed shell, so that a pivoting impeller is arranged on the top wall of the water chamber, and thus the impeller and the pump shell are not communicated with each other; furthermore, through the stator arranged in the axial direction, the rotor arranged in the axial direction is driven to rotate, the rotor can be directly arranged on the disk, and the rotor can also drive the disk to rotate through an intermediate piece.

Its advantages are as follows.

Firstly, the water chamber and the pump seat are two independent chambers, so that the fluid does not affect the circuit element, ensuring the service life and use safety of the driving device.

Secondly, the stator and rotor are arranged radially, achieving axial tangency, which simultaneously reduces the overall thickness of the driving device while minimizing the size of the integrated structure of the water chamber and pump seat, effectively improving the aesthetics of the computer water cooling structure.

Thirdly, the structure is simpler, the concave and convex structure is not needed between the water chamber and the pump chamber to realize tangent of the stator and the rotor, and the radial structure can be adopted, so that the production cost of the mold is lower, and the market competitiveness is effectively improved.

Lastly, compared to radial flux motors, axial flux motors (i.e., the driving device in the present disclosure) offer significant advantages under the same output torque, rotating speed, and power conditions: a more than 50% reduction in axial dimension, making them ideal for space-constrained applications; and a weight reduction of approximately 50%, enhancing the maneuverability and achieving lightweight design of the device.

The direction of the pump seat can be arranged vertically or horizontally.

### BRIEF DESCRIPTION OF THE DRAWINGS

FIG. 1 is an exploded view I of the present disclosure.

FIG. 2 is an exploded view II of the present disclosure.

FIG. 3 is a semi-sectional view of a first embodiment of the present disclosure.

FIG. 4 is a cross-sectional view of a second embodiment of the present disclosure.

FIG. 5 is a schematic diagram of a water chamber.

FIG. 6 is a semi-sectional view of a position of a flow guide seat.

FIG. 7 is a top view of a flow guide seat.

FIG. 8 is a schematic diagram of cooperation between a rotor and a stator.

### DETAILED DESCRIPTION OF THE EMBODIMENTS

The technical solutions in the embodiments of the present disclosure will be clearly and completely described below with reference to the accompanying drawings. Obviously, the described embodiments are only a part of the embodiments of the present disclosure, rather than all of the embodiments. Based on the embodiments of the present disclosure, all other embodiments obtained by those of ordinary skill in the art without creative efforts fall within the scope of protection of the present disclosure.

It should be noted that if there are directional indications (such as up, down, left, right, front, back, top, bottom, inside, outside, vertical, transverse, longitudinal, counterclockwise, clockwise, circumferential, radial, axial . . . ), this directional indication is only used to explain the relative positional relationship, movement, etc. between the components in a specific posture (as shown in the accompanying drawings). If the specific posture changes, the directional indication also changes accordingly.

In addition, if there are descriptions involving “first” or “second” etc. in the embodiments of the present disclosure, the descriptions of “first” or “second” etc. are only for descriptive purposes and cannot be understood as instructions or implying its relative importance or implicitly specifying the quantity of the technical feature indicated. Therefore, features defined as “first” and “second” may explicitly or implicitly include at least one of these features. In addition, the technical solutions in various embodiments may be combined with each other, provided that such combinations are realizable by those skilled in the art. Where the combination of technical solutions is contradictory or unfeasible, it shall be deemed that such a combination does not exist and is not within the scope of protection required by the present disclosure.

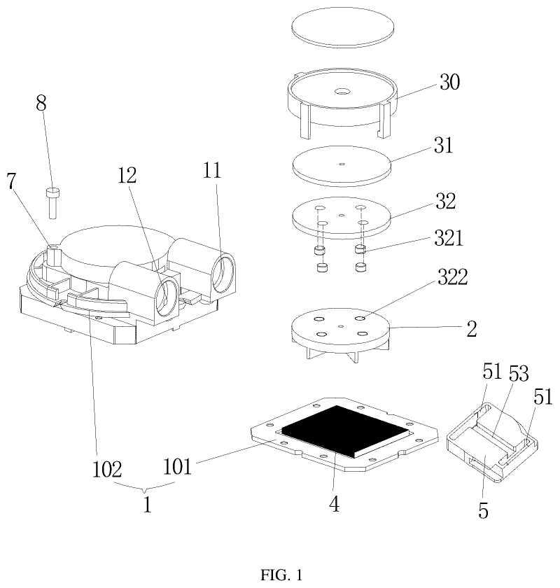

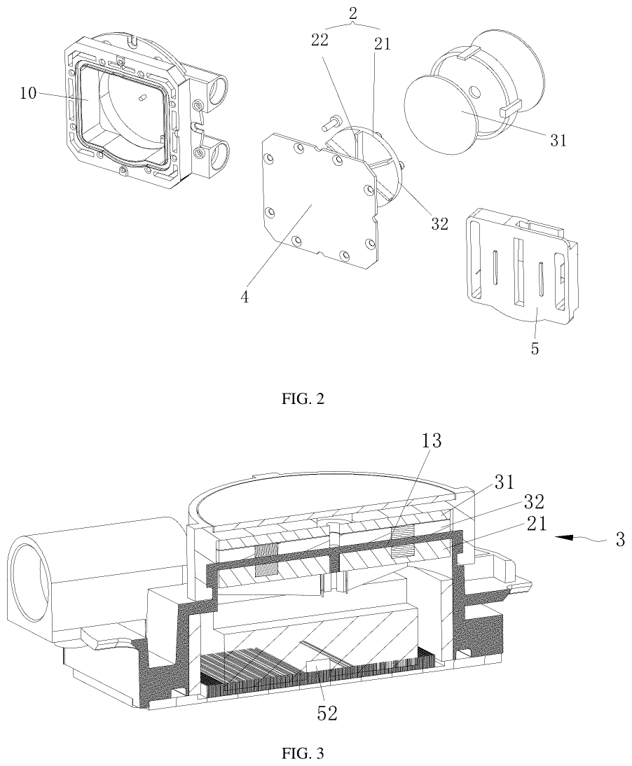

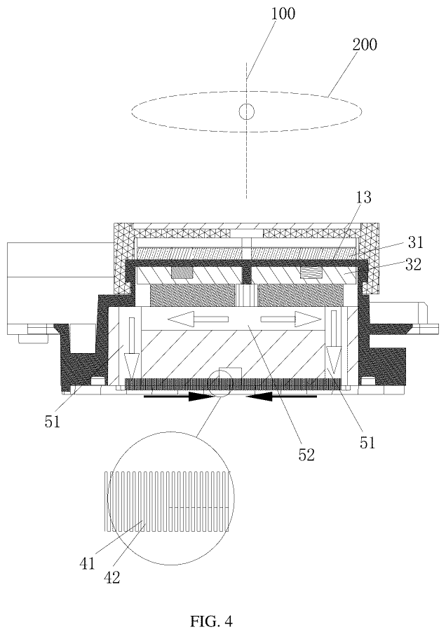

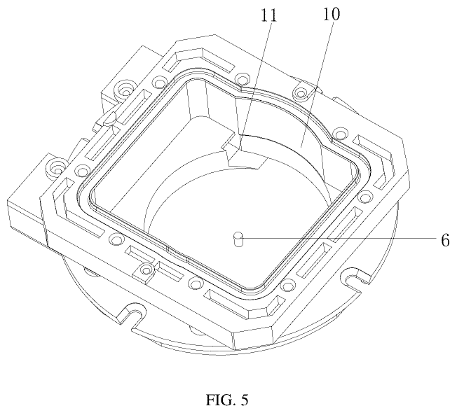

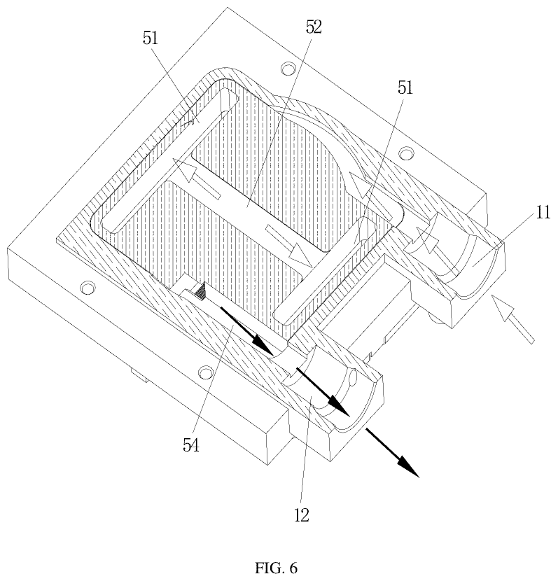

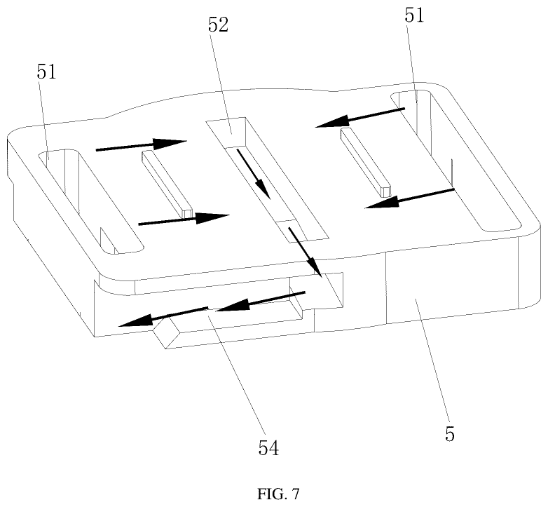

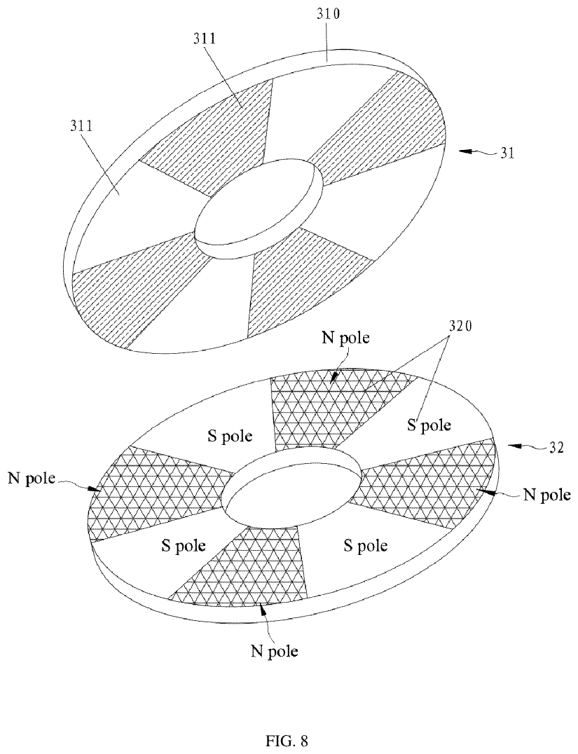

As shown in FIGS. 1 to 8, a cooling assembly for a non-contact driving structure of a computer, comprising:
a water chamber 1, wherein the water chamber 1 is a shell provided with an inner cavity 10 (the shell includes an upper shell 102 and a bottom cover 101, the flow dividing layer 40 and the bottom cover 101 are integrally formed, an opening is formed in a lower end of the upper shell 102, and a clamping groove for installing a sealing ring is formed in a position of the opening, so that the opening and the bottom cover 101 are relatively sealed), an impeller 2 installed in a pivoted mode is arranged on a top wall of the inner cavity 10, a disk 21 extending in a radial direction is arranged on an upper portion of the impeller 2, and the shell is provided with a fluid inlet 11 and a fluid outlet 12;
a driving device 3, wherein the driving device 3 includes a pump seat 30 arranged on an upper wall of the water chamber 1, the pump seat 30 is fixedly provided with a stator 31, the stator 31 is provided with a rotor 32 matched with each other, the rotor 32 and the stator 31 are arranged in the radial direction, the rotor 32 is located below the stator 31, and magnetic fields of the stator 31 and the rotor 32 are axially tangent.

The rotor 32 is arranged on the disk 21 or the rotor 32 drives the disk 21 to rotate through an intermediate piece (i.e., a first magnetic piece and a second magnetic piece); a top wall of the water chamber 1 is a partition plate 13 arranged between the stator 31 and the disk 21; and when the impeller 2 is rotated, the impeller 2 is arranged to drive fluid from the fluid inlet 11 through the water chamber 1 and into the fluid outlet 12.

In the actual design, the water chamber 1 is a relatively enclosed shell, so that a pivoting impeller 2 is arranged on the top wall of the water chamber 1, and thus the impeller 2 and the pump shell are not communicated with each other; furthermore, through the stator 31 arranged in the axial direction, the rotor 32 arranged in the axial direction is driven to rotate, the rotor 32 can be directly arranged on the disk 21, and the rotor 32 can also drive the disk 21 to rotate through an intermediate piece.

Its advantages are as follows.

Firstly, the water chamber 1 and the pump seat 30 are two independent chambers, so that the fluid does not affect the circuit element, ensuring the service life and use safety of the driving device 3.

Secondly, the stator 31 and rotor 32 are arranged radially, achieving axial tangency, which simultaneously reduces the overall thickness of the driving device 3 while minimizing the size of the integrated structure of the water chamber 1 and pump seat 30, effectively improving the aesthetics of the computer water cooling structure.

Thirdly, the structure is simpler, the concave and convex structure is not needed between the water chamber 1 and the pump chamber to realize tangent of the stator 31 and the rotor 32, and the radial structure can be adopted, so that the production cost of the mold is lower, and the market competitiveness is effectively improved.

Lastly, compared to radial flux motors, axial flux motors (i.e., the driving device 3 in the present disclosure) offer significant advantages under the same output torque, rotating speed, and power conditions: a more than 50% reduction in axial dimension, making them ideal for space-constrained applications; and a weight reduction of approximately 50%, enhancing the maneuverability and achieving lightweight design of the device.

The direction of the pump seat 30 can be arranged vertically or horizontally.

Specifically, a bottom wall of the water chamber 1 is a heat conduction surface 4.

Specifically, a convex flow dividing layer 40 is arranged on a wall surface of a bottom wall of the inner cavity 10 opposite to the heat conduction surface 4. In the actual design, the cold head, the water chamber 1 and the pump seat 30 are integrally arranged, so that the cooling assembly can be directly installed on the heating element (such as graphics card and Central Processing Unit (CPU)) with a smaller size and better stability. Meanwhile, the axial driving device 3 is adopted to reduce the overall thickness and weight, which facilitates installation; and the flow dividing layer 40 is used for increasing the contact area of the fluid and the bottom wall of the inner cavity 10, thereby improving the heat exchange effect of the flow guide surface.

Specifically, the flow dividing layer 40 is composed of a plurality of heat conducting strips 41 arranged at intervals, and a flow guide groove 42 is enclosed between two heat conducting strips 41, so that the fluid can flow in a preset direction, and the heat exchange efficiency is improved.

Specifically, the stator 31 includes a support 310 and a magnetic induction coil 311 arranged on the support 310 at intervals, and a magnetic induction direction of the magnetic induction coil 311 is axial; and the rotor 32 is provided with a plurality of permanent magnets 320. The structure thereof can be referred to as an axial flux motor, and the rotation of the rotor 32 is further controlled by controlling the direction of the current.

In the first embodiment, when one of the plurality of permanent magnets 320 is arranged on the disk 21, the stator 31 directly drives one of the plurality of permanent magnets 320 and drives the impeller 2 to rotate, and the partition plate 13 is arranged between the stator 31 and the rotor 32. By eliminating the air gap, this structure addresses the issue of unstable heat dissipation in axial flux motors. Specifically, with the rotor 32 positioned inside the water chamber 1, it can fully dissipate heat. In principle, the magnetic field of one of the plurality of permanent magnets 320 remains stable, making the stator 31 (which is the magnetic induction coil 311 section) the primary element prone to damage. As a result, even if the cooling assembly malfunctions, simply replacing the stator 31 facilitates the maintenance process, significantly enhancing repair convenience.

Specifically, the rotor 32 and the disk 21 are integrally injection-molded, thereby effectively protecting the structure of the stator 31, and improving the stability of one of the plurality of permanent magnets 320.

Specifically, magnetic field projection areas of the stator 31 and the rotor 32 are consistent, thereby ensuring the driving stability and avoiding the problem of magnetic field loss.

Specifically, one of the plurality of permanent magnets 320 is distributed on the rotor 32 in a fan shape, one of the plurality of permanent magnets 320 includes an S pole and an N pole, and the S pole and the N pole are adjacently arranged, thereby achieving magnetic field tangency.

In the second embodiment, the rotor 32 is pivotally installed between the upper wall of the water chamber 1 and the pump seat 30, the rotor 32 is provided with a first magnetic piece 321, the first magnetic piece 321 is one of the plurality of permanent magnets 320, the disk 21 is provided with a second magnetic piece 322 matched with the first magnetic piece 321, and the partition plate 13 is arranged between the rotor 32 and the disk 21. In general, the rotor 32 is further provided with an iron core and other structures for fixing one of the plurality of permanent magnets 320, and when one of the plurality of permanent magnets 320 is integrally injection-molded, the magnetic pole of one of the plurality of permanent magnets 320 can be fixed by reducing the use of the iron core.

Specifically, the support 310 is a Printed Circuit Board (PCB) or an iron core. In the actual design, the magnetic induction coil 311 is preferentially wound by adopting the PCB, so that the control of the circuit is facilitated, and the thickness of the circuit is smaller.

Specifically, the driving device 3 is installed on the pump seat 30, and the pump seat 30 is detachably installed on an upper wall of the shell, thereby facilitating maintenance or replacement.

Specifically, clamping holes are formed in a peripheral wall or the upper wall of the shell, clamping hooks matched with the clamping holes are arranged on two sides of the pump seat 30, and the clamping hooks are arranged to extend into the clamping holes and hook the clamping holes. The pump shell can also be fixed in a screw mode, and then installation is convenient.

Specifically, the impeller 2 includes blades 22 arranged on a lower wall of the disk 21, and the blades 22 are spaced apart and distributed circumferentially around an axis of the disk 21. The specific blade can be in an arc shape, a strip shape or a curved surface structure, so that the flow of the fluid in the predetermined direction is realized.

Specifically, the water chamber 1 is provided with a flow guide seat 5, the flow guide seat 5 is provided with a flow dividing channel, and the impeller 2 can drive fluid to sequentially pass through the fluid inlet 11, the flow dividing channel and the flow dividing layer 40, and flow towards the fluid outlet 12. The arrangement of the flow guide seat 5 can reduce the generation of turbulent flow, enabling the fluid to flow in an orderly manner, thereby enhancing the heat dissipation effect.

Specifically, the flow dividing channel includes a first flow channel 51 and a second flow channel 52, where a number of the first flow channel 51 is two, the two first flow channels 51 are arranged at intervals, and the second flow channel 52 is arranged on a bottom wall of the flow guide seat 5; the first flow channel 51 penetrates through the flow guide seat 5, a lower end of the first flow channel 51 is communicated with the flow dividing layer 40, and fluid passes through the flow dividing layer 40 and then flows to the second flow channel 52.

An upper wall of the flow guide seat 5 is provided with a groove 53 for communicating the two first flow channels 51. When the impeller 2 rotates, the fluid generally flows outward from the axis, thereby generating fluid pressure. Therefore, by arranging the flow dividing channel on both sides, the fluid can flow from both ends of the flow dividing layer 40 towards the middle, and finally pass through the second flow channel 52 in the middle to the fluid outlet 12.

Specifically, an end of the flow guide seat 5 is provided with a through groove 54, the through groove 54 is communicated with the fluid outlet 12, and the second flow channel 52 is bent and extends to the through groove 54.

Specifically, a first rotating shaft 6 extends downwards from a top wall of the inner cavity 10, and the first rotating shaft is configured to install the impeller 2.

Specifically, a bearing is arranged between the rotating shaft and the impeller 2, and the bearing can be of a corrosion-resistant structure such as a ceramic bearing, so that the use stability is improved.

Specifically, the pump seat 30 is provided with a pivoting portion, and the pivoting portion is configured to install the rotor 32 to enable the rotor 32 to rotate. Of course, for the rotor 32 with a disc-type structure, the pivoting portion can also be a bearing arranged on the outer side of the rotor 32; or a second rotating shaft arranged in the middle of the rotor 32; or bearings arranged on both the inner and outer sides of the device.

In the embodiment of the present disclosure, the water chamber is provided with a through hole 7 extending into the inner cavity, and a sensor 8 is detachably installed in the through hole; the sensor can detect a water temperature, a water quality, a fluid pressure and a liquid level of the fluid in the inner cavity; the sensor is connected with a control device, the control device is further connected with the driving device, and the control device controls a rotating speed of the impeller according to a data detected by the sensor. The sensor is connected with the driving device through wires, because the driving device integrates a control board (i.e., the control device is arranged on the driving device). At the same time, the control device can also integrate a wireless transceiver, which can directly control the driving device without a computer interface. It only needs to provide power supply for the water pump, thus reducing the number of wires that will be exposed outside. At the same time, the data of the sensor will participate in calculating the rotating speed strategy of the water pump.

The above descriptions are only preferred embodiments of the present disclosure and are not intended to limit the patent scope of the present disclosure, and any equivalent structural transformation made by the description and drawings of the present disclosure or direct/indirect application in other related technical fields is included in the patent protection scope of the present disclosure under the inventive concept of the present disclosure.

What is claimed is:

1. A cooling assembly for a non-contact driving structure of a computer, comprising:
a water chamber, wherein the water chamber is a shell provided with an inner cavity, an impeller installed in a pivoted mode is arranged on a top wall of the inner cavity, a disk extending in a radial direction is arranged on an upper portion of the impeller, and the shell is provided with a fluid inlet and a fluid outlet; and
a driving device, wherein the driving device comprises a pump seat arranged on an upper wall of the water chamber, the pump seat is fixedly provided with a stator, the stator is provided with a rotor matched with each other, the rotor and the stator are arranged in the radial direction, the rotor is located below the stator, and magnetic fields of the stator and the rotor are axially tangent; wherein
the rotor is arranged on the disk or the rotor drives the disk to rotate through an intermediate piece;
a top wall of the water chamber is a partition plate arranged between the stator and the disk; and
when the impeller is rotated, the impeller is arranged to drive fluid from the fluid inlet through the water chamber and into the fluid outlet.

2. The cooling assembly for the non-contact driving structure of the computer according to claim 1, wherein a bottom wall of the water chamber is a heat conduction surface.

3. The cooling assembly for the non-contact driving structure of the computer according to claim 2, wherein a convex flow dividing layer is arranged on a wall surface of a bottom wall of the inner cavity opposite to the heat conduction surface.

4. The cooling assembly for the non-contact driving structure of the computer according to claim 3, wherein the flow dividing layer is composed of a plurality of heat conducting strips arranged at intervals, and a flow guide groove is enclosed between two adjacent heat conducting strips.

5. The cooling assembly for the non-contact driving structure of the computer according to claim 1, wherein the stator comprises a support and a magnetic induction coil arranged on the support at intervals, and a magnetic induction direction of the magnetic induction coil is axial; and
the rotor is provided with a plurality of permanent magnets.

6. The cooling assembly for the non-contact driving structure of the computer according to claim 5, wherein when one of the plurality of permanent magnets is arranged on the disk, the stator directly drives one of the plurality of permanent magnets and drives the impeller to rotate, and the partition plate is arranged between the stator and the rotor.

7. The cooling assembly for the non-contact driving structure of the computer according to claim 6, wherein the rotor and the disk are integrally injection-molded.

8. The cooling assembly for the non-contact driving structure of the computer according to claim 5, wherein magnetic field projection areas of the stator and the rotor are consistent.

9. The cooling assembly for the non-contact driving structure of the computer according to claim 5, wherein one of the plurality of permanent magnets is distributed on the rotor in a fan shape, one of the plurality of permanent magnets comprises an S pole and an N pole, and the S pole and the N pole are adjacently arranged.

10. The cooling assembly for the non-contact driving structure of the computer according to claim 5, wherein the rotor is pivotally installed between the upper wall of the water chamber and the pump seat,
the rotor is provided with a first magnetic piece, the first magnetic piece is one of the plurality of permanent magnets, and the partition plate is arranged between the rotor and the disk.

11. The cooling assembly for the non-contact driving structure of the computer according to claim 1, wherein the water chamber is provided with a through hole extending into the inner cavity, and a sensor is detachably installed in the through hole;
the sensor is configured to detect a water temperature, a water quality, a fluid pressure and a liquid level of an inner cavity fluid; and
the sensor is connected with a control device, the control device is further connected with the driving device, and the control device controls a rotating speed of the impeller according to a data detected by the sensor.

12. The cooling assembly for the non-contact driving structure of the computer according to claim 1, wherein the driving device is installed on the pump seat, and the pump seat is detachably installed on an upper wall of the shell.

13. The cooling assembly for the non-contact driving structure of the computer according to claim 12, wherein clamping holes are formed in a peripheral wall or the upper wall of the shell, clamping hooks matched with the clamping holes are arranged on two sides of the pump seat, and the clamping hooks are arranged to extend into the clamping holes and hook the clamping holes.

14. The cooling assembly for the non-contact driving structure of the computer according to claim 12, wherein the impeller comprises a plurality of blades arranged on a lower wall of the disk, one of the blades extends from an axis of the disk to a periphery along a radius of the disk, and the plurality of the blades are distributed at intervals.

15. The cooling assembly for the non-contact driving structure of the computer according to claim 3, wherein the water chamber is provided with a flow guide seat, the flow guide seat is provided with a flow dividing channel, and the impeller can drive fluid to sequentially pass through the fluid inlet, the flow dividing channel and the flow dividing layer, and flow towards the fluid outlet.

16. The cooling assembly for the non-contact driving structure of the computer according to claim 3, wherein the flow dividing channel comprises a first flow channel and a second flow channel, where a number of the first flow channel is two, the two first flow channels are arranged at intervals, and the second flow channel is arranged on a bottom wall of the flow guide seat; the first flow channel penetrates through the flow guide seat, a lower end of the first flow channel is communicated with the flow dividing layer, and fluid passes through the flow dividing layer and then flows to the second flow channel; and
an upper wall of the flow guide seat is provided with a groove for communicating the two first flow channels.

17. The cooling assembly for the non-contact driving structure of the computer according to claim 16, wherein an end of the flow guide seat is provided with a through groove, the through groove is communicated with the fluid outlet, and the second flow channel is bent and extends to the through groove.

18. The cooling assembly for the non-contact driving structure of the computer according to claim 1, wherein a first rotating shaft extends downwards from a top wall of the inner cavity, and the first rotating shaft is configured to install the impeller.

19. The cooling assembly for the non-contact driving structure of the computer according to claim 4, wherein the shell comprises an upper shell and a bottom cover, the flow dividing layer and the bottom cover are integrally formed, an opening is formed in a lower end of the upper shell, and a clamping groove for installing a sealing ring is formed in a position of the opening.

20. The cooling assembly for the non-contact driving structure of the computer according to claim 10, wherein the pump seat is provided with a pivoting portion, and the pivoting portion is configured to install the rotor to enable the rotor to rotate.
